(19) United States
(12) Patent Application Publication
(10) Pub. No.: US 2017/0195983 A1
(43) Pub. Date: Jul. 6, 2017

(54) ACCESS CLASS BARRING FOR MOBILE TERMINATED COMMUNICATION AND ACTIVE MOBILITY

(71) Applicant: VODAFONE IP LICENSING LIMITED, London (GB)

(72) Inventors: Youssef CHAMI, London (GB); Christopher PUDNEY, London (GB); Assen GOLAUP, London (GB)

(21) Appl. No.: 15/314,484

(22) PCT Filed: May 27, 2015
(86) PCT No.: PCT/EP2015/061760

§ 371 Date: Nov. 28, 2016

(30) Foreign Application Priority Data
May 28, 2014 (GB) 1409483.3

(51) Int. Cl. H04W 60/06; H04W 48/16; H04W 68/12; H04W 36/00; H04W 76/06; H04W 8/18; H04W 12/06

(52) U.S. Cl. CPC H04W 60/06; H04W 8/18; H04W 48/16; H04W 12/06; H04W 36/0077; H04W 76/064; H04W 68/12

(57) ABSTRACT

A wireless network controller and method for controlling the performance of a requested network service for a user equipment within a wireless network. The wireless network controller is configured to compare an access permission of the user equipment to an access condition of a wireless network cell associated with the requested network service, and if the access permission of the user equipment does not comply with the access condition of the wireless network cell associated with the requested network service, suppress the requested network service such that the network service is not performed.

### TECHNICAL FIELD

The present disclosure relates to controller and a method for controlling a requested network service in a wireless network.

### BACKGROUND

The Third Generation Partnership Project (3GPP) has been developing enhancements to cellular systems to allow their operation for public safety or emergency services (ES) communications. These are especially intended to work with the Long Term Evolution (LTE) architecture. Aims of this approach may include: reduced cost; improved functionality; and increased flexibility in comparison with existing public safety communication infrastructure, such as the Terrestrial Trunked Radio (TETRA) network.

The objectives specified for critical voice and broadband services are that it should be affordable, to address pressures on user budgets; that it should be enhanced relative to the TETRA network, in order to provide integrated broadband services to meet user needs; and that it should be flexible, so as better to match and be responsive to user demand.

In order to achieve these objectives, the UK government has proposed a 4-lot procurement model:

1. Integration of services to migrate between legacy and new solutions
2. Services and User functionalities
3. Basic coverage using the commercial 4G (LTE) network

### 4. Coverage Extension

Commercial User Equipment (UE)—that is, typically, a handset such as a mobile telephone—is allocated randomly to one out of ten network access classes. The random allocation is performed by the SIM manufacturer or the service provider and is provisioned at the SIM/USIM prior to customer use. The allocation may be reconfigured for over-the-air (OTA)) mobile populations, defined as Access Classes (AC) 0 to 9. The population number is stored in the SIM/USIM.

In addition, UEs may be members of one or more out of 5 special (high priority) categories (Access Classes 11 to 15), also held in the SIM/USIM. These are allocated to specific high priority users. The allocation is performed on-demand by customer services and the value provisioned OTA.
Class 15—PLMN Staff;
Class 14—Emergency Services;
Class 13—Public Utilities (e.g. water/gas suppliers);
Class 12—Security Services;
Class 11—For PLMN Use.

The skilled reader will recognise that none of the access class numbers are indicative of a hierarchy of importance, save that access classes 0-9 are reserved for commercial users whereas access classes 10-15 are reserved for higher priority users including the ES.

Currently, the network is able to support access control based on the type of access attempt (i.e. mobile originating data or mobile originating signalling, in which indications to the UEs are broadcast to guide the behaviour of UE. The network shall be able to form combinations of access control based on the type of access attempt e.g. mobile originating and mobile terminating, mobile originating, or location registration. The ‘mean duration of access control’ and the barring rate are broadcast for each type of access attempt (i.e. mobile originating data or mobile originating signalling).

In certain situations, the cell home office, or its agencies may request the Lot 3 and 4 operator(s) to activate Access Class Barring (ACB) Capability to all commercial users. e.g. in case there is a threat to detonate a bomb through a mobile phone. However, it is desirable to allow only ES users to continue to communicate using the same cell. In this case, it is desirable for all Mobile Originated (MO), Mobile Terminated (MT) and Handover commercial users to be prevented from using the cell(s) in a specific geographical area(s). The cell and/or the geographical areas may be pre-determined by lot 2 or 3 or jointly.

The requirements for ACB are described in 3GPP TS 22.011 Section 4 and the signalling specified in 3GPP TS 36.331. The access class barring configuration is activated by the RAN O&M system and there is no data or control from the Core network. The 3GPP specified procedure can thus prevent access for mobile originating calls from UEs with AC0-9 whilst allowing access for UEs with special access classes

For mobile terminated (MT) calling, the paging message is still broadcast to all UEs belonging to the same tracking area as the target Emergency Services UE and which ‘wake up’ in the same paging occasion. All UEs will ignore the paging message, except the UE that is being paged.

If the lot 3 cells (allowed for commercial UEs) and Lot 4 cells (allowed for emergency services UEs only) are planned to be part of different tracking areas, then commercial UEs will never register on the TA of the lot 4 cells as they cannot access those cells. Hence, when a MT call comes for a commercial UE, it will only be sent to evolved Node Bs (eNBs) which form part of the commercial UEs tracking areas. Thus, the lot 4 cells will not be impacted by paging load from commercial UEs. For MT calls to Emergency services UEs, those UEs will be paged using the UE's IMSI and the paging message is broadcast in cells that are part of the lot 4 Tracking area.

However, if the lot 3 cells and lot 4 cells are planned to be part of the same tracking area and barring of MT calls is only required for commercial UEs in the lot 4 cells, then commercial UEs will still need to be paged. The paging messages will go to both the lot 3 cells and the lot 4 cells. Even though the commercial UE will not be in the lot 4 cells, the paging message for that commercial UE will still be broadcast in the lot 4 cell.

Therefore, the Emergency services UEs will receive the paging messages for commercial UEs and commercial UEs will receive the paging messages for Emergency services UEs.

The standard implementation rely on the commercial UE is to ignore the paging request for access class barring for AC11-15 sent by the core network. However, there is no guarantee to prevent the UE from NOT responding to paging request when using 3G/4G networks for MO and for the MT (which may not be supported in today implementation).

One of the challenges of supplying ES communications over a commercial LTE network is to ensure that commercial users can be barred from 11 Mobile Originated (MO), Mobile Terminated (MT) and Handover actions in a specific cell or cells/geographical area(s), whilst still allowing ES UEs to utilise those same cells, even when the TA(s) of which those cells are a part include both lot 3 and lot 4 cells.

### SUMMARY

The present disclosure provides a wireless network controller for controlling the performance of a requested network service for a user equipment within a wireless network (for example, paging the UE using a cell in the network or handing the UE over to a target cell), the wireless network controller being configured to: compare an access permission of the user equipment to an access condition of a wireless network cell associated with the requested network service; and if the access permission of the user equipment does not comply with the access condition of the wireless network cell associated with the requested network service, suppress the requested network service such that the network service is not performed.

A method for controlling the performance of a requested network service for a user equipment within a wireless network (for example, paging the UE using a cell in the network or handing the UE over to a target cell), the method comprising: comparing an access permission of the user equipment to an access condition of a wireless network cell associated with the requested network service; and if the access permission of the user equipment does not comply with the access condition of the wireless network cell associated with the requested network service, suppressing the requested network service such that the network service is not performed.

Aspects of the disclosure are also set in the following numbered clauses:

Clause 1.
A wireless network controller for controlling the broadcast of a paging message for a user equipment by a wireless network cell, the wireless network controller being configured to:
compare an access permission of the user equipment to an access condition of the wireless network cell; and
if the access permission of the user equipment does not comply with the access condition of the wireless network cell, suppress the paging message such that it is not broadcast on the wireless network cell.

Clause 2.
The controller of clause 1, wherein the paging message comprises an identifier of the user equipment, the controller being further configured to:
determine the access permission of the user equipment using the identifier of the user equipment.

Clause 3.
The controller of clause 1, wherein the paging message comprises an indication of the access permission of the user equipment.

Clause 4.
The controller of any preceding clause, wherein:
the access permission of the user equipment comprises an access class of the user equipment; and
the access condition of the wireless network cell comprises an indication of the access classes that are allowed to use the wireless network cell.

Clause 5.
The controller of any preceding clause, wherein:
the access permission of the user equipment indicates whether or not the user equipment is an emergency services user equipment; and
the access condition of the wireless network cell indicates if the wireless network cell is reserved for emergency services user equipment only, or if other user equipment is allowed to use the wireless network cell.

Clause 6.
The controller of any preceding clause, wherein the controller is an Evolved Node B.

Clause 7.
A method for controlling the broadcast of a paging message for a user equipment by a wireless network cell, the method comprising the steps of:
comparing an access permission of the user equipment to a access condition of the wireless network cell; and
if the access permission of the user equipment does not comply with the access condition of the wireless network cell, suppressing the paging message such that it is not broadcast on the wireless network cell.

Clause 8.
A controller for controlling handover of a user equipment from a serving wireless network cell to a target wireless network cell, the controller being configured to:
receive a request for handover of the user equipment from the serving wireless network cell to the candidate wireless network cell;
compare an access permission of the user equipment to an access condition of a target wireless cell; and
if the access permission of the user equipment does not comply with the access condition of the target wireless network cell, suppress handover of the user equipment to the target wireless network cell.

Clause 9.
The controller of clause 8, being further configured to:
query the access condition of the target wireless network cell; and
receive an indication of the access condition of the target wireless network cell.

Clause 10.
The controller of either clause 7 or clause 8, wherein the request for handover of the user equipment from the serving wireless network cell to the candidate wireless network cell comprises an identifier of the user equipment, the controller being further configured to:
determine the access permission of the user equipment using an identifier of the user equipment.

Clause 11.
The controller of either clause 7 or clause 8, wherein the request for handover of the user equipment from the serving wireless network cell to the candidate wireless network cell comprises an indication of the access permission of the user equipment.

Clause 12.

The controller of any of clauses 8 to 11, wherein:
the access permission of the user equipment comprises an access class of the user equipment; and
the access condition of the target wireless network cell comprises an indication of the access classes that are allowed to use the target wireless network cell.

Clause 13.

The controller of any of clauses 8 to 12, wherein:
the access permission of the user equipment indicates whether or not the user equipment is an emergency services user equipment; and
the access condition of the wireless network cell indicates if the wireless network cell is reserved for emergency services user equipment, or if other user equipment is allowed to use the wireless network cell.

Clause 14.

The controller of any of clauses 8 to 13, wherein the controller is an Evolved Node B.

Clause 15.
A method for controlling handover of a user equipment from a serving wireless network cell to a target wireless network cell, the method comprising:
receiving a request for handover of the user equipment from the serving wireless network cell to the candidate wireless network cell;
comparing an access permission of the user equipment to an access condition of a target wireless cell; and
if the access permission of the user equipment does not comply with the access condition of the target wireless network cell, suppressing handover of the user equipment to the target wireless network cell.

### BRIEF DESCRIPTION OF THE DRAWINGS

The invention may be put into practice in a number of ways, and some preferred embodiments will now be described by way of example only and with reference to the accompanying drawings, in which:

FIG. 1 shows a highly schematic diagram of a network architecture for a cellular network and communications steps for controlling the handover of an active or idle user equipment device (UE) to a restricted cell;

FIG. 2 shows a sequence diagram representing how the broadcast of a paging message on a cell(s) may be controlled based on the access permission of the UE and the access condition of the cell(s);

FIG. 3 shows a further sequence diagram representing an alternative technique for controlling the broadcast of a paging message on a cell(s) based on the access permission of the UE and the access condition of the cell(s); and

FIG. 4 shows a sequence diagram representing how the handover of an active UE to a target cell may be controlled based on the access permission of the UE and the access condition of the target cell.

### DETAILED DESCRIPTION

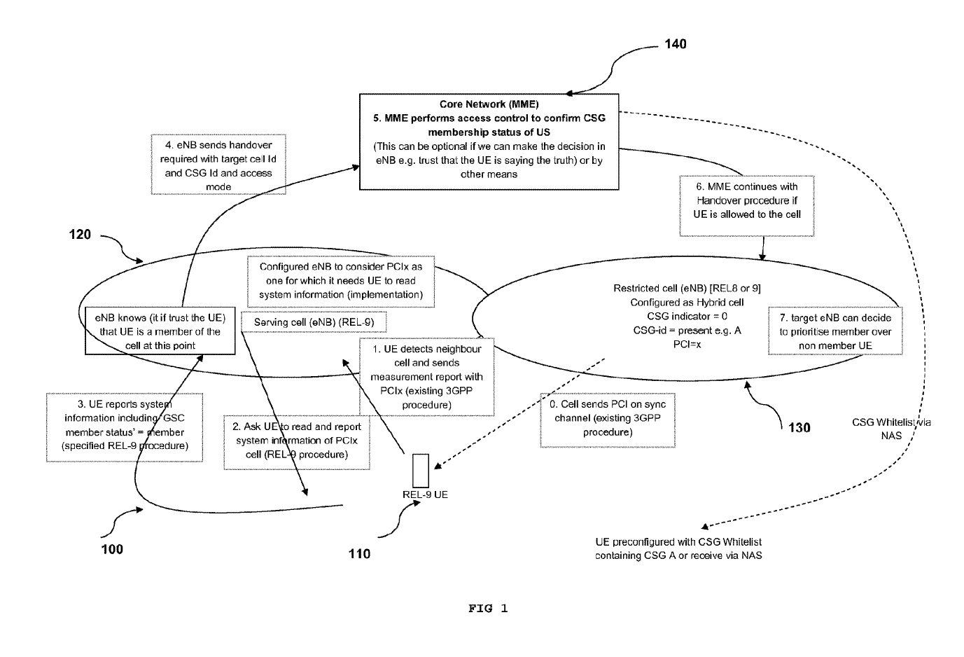

Referring to FIG. 1, there is shown a highly schematic diagram of a part of a telecommunications network (E-UTRAN) 100. The network 100 comprises a User Equipment node (UE) 110 in communication with a serving wireless network cell 120 (which is controlled by a evolved Node B, eNB).

It will of course be understood that a typical serving cell 120 will often be communicating with many more UEs (of both the commercial and ES type) at any given time and that there is no particular significance to be given to the number of UEs represented in FIG. 1. Hence, FIG. 1 is intended merely to illustrate the principles of the present invention.

FIG. 1 shows steps that may be performed for controlling the handover of the UE 110 from the serving cell 120 to a target cell 130, which is a restricted cell.

For idle and connected mode mobility management from lot 3 to lot 4 (not for commercial use), it is possible to restrict idle mode cell selection/reselection and handover to lot 4 cells (not for commercial use), by designating those cells as closed cells, according to 3GPP femtocell specifications (See TS 36.300 and TS 36.331). The Lot 4 cell will have to broadcast a ‘CSG indicator’ and a ‘CSG ID’. The UE will interpret the setting of those IEs in the system information as follows:

CSG Indicator=false& CSG ID=not present means this is an ‘open cell’. This is how the macro network operates.
CSG indicator=true & CSG ID=present (must be present) means the cell is a closed cell

UE will not select a closed cell unless it has been provisioned with a CSG Whitelist containing a CSG id broadcast by the cell (member UEs). Moreover, only member UEs will be handed over to closed cells.

CSG indicator=False & CSG ID=present means the cell is a hybrid cell

All UEs can select and reselect to the cell as if it is a normal cell. At handover, commercial UEs will also be handed over to the Lot 4 cells.

However, the UE will be able to indicate to the network whether it is a member or non-member of the CSG ‘group’ corresponding to the CSG id broadcast by the cell. This information will trigger the MME to perform a membership verification check and gives the opportunity to the eNB of the lot 4 cell to pre-empt commercial UEs to allow Emergency services UEs to access or not allow them to handover at all.

FIG. 1 shows the process steps 0-7 by which it may be determined whether or not the UE 110 should be allowed to handover to the restricted cell 130.

Whilst this process may be effective for preventing commercial UEs from handing over to lot 4 cell, the main issue with the ‘CSG Group’ approach is that it requires the deployment of new features in the radio access network, requires special UEs, functionality on the core network and a provisioning framework to manage allocation of CSG Ids for different groups of UEs. The simplest allocation will be to group all Emergency Services UEs under one closed subscriber group and hence they will only be able to access lot 4 cells broadcasting the respective CSG Id.

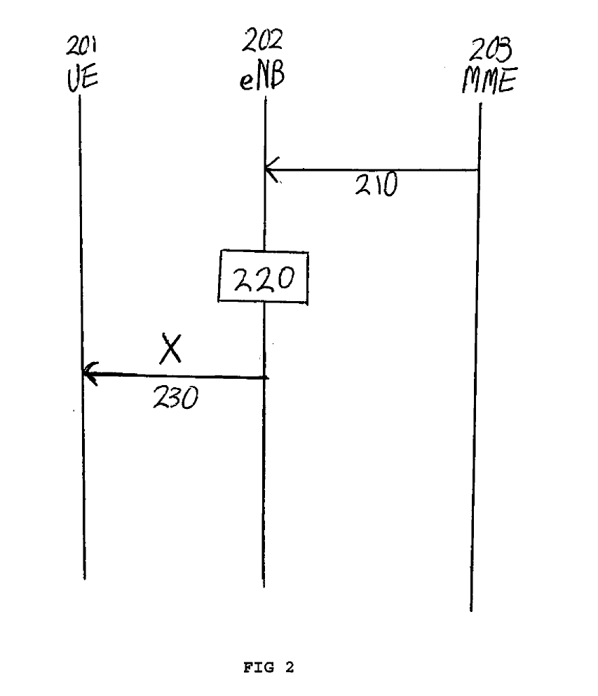

In an alternative aspect of the present disclosure, FIG. 2 shows a sequence diagram representing a process by which the broadcast of a paging message may be controlled or blocked from broadcast on a wireless network cell controlled by an eNB 220.

In step 210, the eNB 202 receives from a mobile management entity (MME) 203, or alternatively any suitable network or core network (CN) element, a paging message. The paging message may be considered to be a request for the network service of broadcasting a paging message to a UE 201 using a cell(s) that the eNB 202 serves.

In step 220, the eNB 202 determines the access permission of the UE 201. The access permission may comprise an indication of the access permission of the UE 201. The access permission may comprise an indication of whether or not the UE 201 is a special case UE 201 (for example, an emergency services UE), as opposed to a commercial UE. In addition, or as an alternative, the access permission may comprise an indication of which access class (AC) the UE 201 supports (for example, one of AC 0-9 or 11-15). The eNB 202 may determine the access permission of the UE 201, for example, by mapping the identifier of the UE 201 (for example, the IMPI or IMSI of the UE) in the paging message to a database of the identities of special case UEs, and/or by looking up the identifier of the UE in a database to find access permission that has been recorded for the UE. The database may be kept on the eNB 202, or in a different location that is accessible by the eNB 202.

The eNB 202 may then in step 220 compare the access permission of the UE 201 to the access condition of the cell(s) on which the paging message is to be broadcast, for example to determine if it is a lot 3 or a lot 4 cell. The eNB 202 may check the current access condition of the cell(s) on which the paging message is to be broadcast. The current access condition may be, for example, an indication that only special case UEs (for example, emergency services UEs) are allowed to use the cell(s) and that all other types of UE are barred from using the cell(s) (i.e. it is a lot 4 cell), and/or an indication of the ACs (for example, ACs 0-9) that are barred from using the cell(s) (with the implication being that all other ACs are allowed to use the cell(s)), and/or an indication of the ACs (for example, AC 14) that are allowed to use the cell(s) (with the implication being that all other ACs are barred from using the target cell) and/or an indication of the ACs that are allowed to use the cell(s) and an indication of the ACs that are barred from using the cell(s).

If the access permission of the UE 201 does not comply with the access condition of the cell(s), the eNB 202 may suppress the paging message such that it is not broadcast on the cell(s) (thereby suppressing the requested network service such that it is not performed). For example, if the cell(s) has an access condition of allowing only special case UEs to use the cell(s) and the access permission of the UE 201 does not indicate that it is a special case UE (for example, it is a commercial UE), the eNB 202 will suppress the paging message. In a further example, if the access condition of the cell(s) is barring of ACs 0-9 (thus, allowing other ACs to use the target cell) and the access permission of the UE 201 indicates that the UE 201 supports an access class of 0-9, again the eNB 202 will suppress the paging message.

If, on the other hand, the access permission of the UE 201 does comply with the access condition of the cell(s), the eNB 202 may allow the paging message to be broadcast on the cell(s) in step 230. For example, if the access condition of the cell(s) is to allowing AC 14 to use the cell(s) and the access permission of the UE 201 indicates that the UE supports an access class of 14, the serving eNB 202 will allow paging message to be broadcast in step 230.

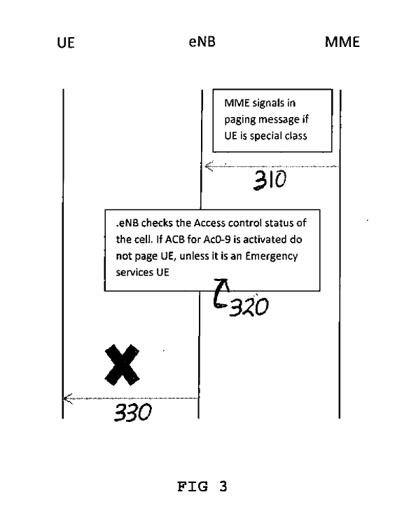

FIG. 3 shows a sequence diagram representing an alternative process by which the broadcast of a paging message may be controlled or blocked from broadcast on a wireless network cell controlled by eNB 202.

In step 310, the eNB 202 receives from the mobile management entity (MME) 203, or alternatively any suitable network or core network (CN) element, a paging message. The paging message may be considered to be a request for the network service of broadcasting a paging message to the UE 201 using a cell(s) that the eNB 202 serves. The paging message comprises an indication from the CN of the access permission of the UE 201 for which the paging message is intended. For example, the paging message may indicate that the UE 201 for which the paging message is intended is a special case UE (for example, an emergency services UE), as opposed to a commercial UE, and/or may indicate the AC supported by the UE 201. The indication of the access permission of the UE 201 may be included in the paging message as a modification of the paging message defined in 3GPP standards, for example in TS 36.331, which specifies UE behaviour at RRC Connection establishment when access class barring is turned on.

In Step 320, the eNB 202 may check the current access condition of the cell(s) on which the paging message is to be broadcast. The current access condition may be, for example, an indication that only special case UEs (for example, emergency services UEs) are allowed to use the cell(s) and that all other types of UE are barred from using the cell(s), and/or an indication of the ACs (for example, ACs 0-9) that are barred from using the cell(s) (with the implication being that all other ACs are allowed to use the cell(s)), and/or an indication of the ACs (for example, AC 14) that are allowed to use the cell(s) (with the implication being that all other ACs are barred from using the target cell) and/or an indication of the ACs that are allowed to use the cell(s) and an indication of the ACs that are barred from using the cell(s).

The eNB 202 may then in step 320 compare the access permission of the UE 201 to the access condition of the cell(s) on which the paging message is to be broadcast. If the access permission of the UE 201 does not comply with the access condition of the cell(s), the eNB may suppress the paging message such that it is not broadcast on the cell(s) (thereby suppressing the requested network service such that it is not performed). For example, if the cell(s) has an access condition of allowing only special case UEs to use the cell(s) (i.e. the cell is a lot 4 cell) and the access permission of the UE 201 does not indicate that it is a special case UE, the eNB 202 will suppress the paging message. In a further example, if the access condition of the cell(s) is barring of ACs 0-9 (thus, allowing other ACs to use the target cell) and the access permission of the UE 201 indicates that the UE 201 supports an access class of 0-9, again the eNB 202 will suppress the paging message.

If, on the other hand, the access permission of the UE 201 does comply with the access condition of the cell(s), the eNB may allow the paging message to be broadcast on the cell(s) in step 230. For example, if the access condition of the cell(s) is to allowing AC 14 to use the cell(s) and the access permission of the UE 201 indicates that the UE 201 supports an access class of 14, the serving eNB 202 will allow paging message to be broadcast in step 330.

By controlling the broadcast of paging messages using either of the techniques shown in FIGS. 2 and 3 and describes above, the broadcast of paging messages for commercial UEs (for example, UEs that support an AC between 0-9 and/or are not designated as special case UEs, such as emergency services UEs) using a cell(s) that is restricted for particular ACs (for example, AC 14, or ACs 11-14), such as a lot 4, and/or for use by special case UEs (such as emergency services UEs) may be prevented, even where restricted and unrestricted cells are in the same tracking area (TA). Thus, commercial UEs will not be able to receive paging messages from a lot 4 and will therefore not be able to conduct mobile terminated (MT) communications (for example, phone call, data sessions, receipt of SMS message etc) via a lot 4 cell. Furthermore, special case UEs and/or UEs with allowed ACs (for example, AC 14 or AC 11-14) will not receive paging messages for commercial UEs via lot 4 cells, thereby reducing the overhead for the lot 4 cells and for the special case UEs.

Therefore, communication to and from all commercial UEs may be barred on a lot 3 cell(s) and/or a lot 4 cell(s) whilst still allowing communication to and from special case UEs such as ES UEs and/or UEs with allowed ACs (for example, AC 14 or AC 11-14), even when lot 3 and lot 4 are part of the same tracking area (TA). Thus, in an emergency situation such as where bomb detonation by a commercial UE is a risk, mobile terminated (MT) communication with the UE 201 may be prevented within a particular area served by lot 3 and/or lot 4 cell(s) whilst still allowing emergency services UEs to conduct MT communication within the same area.

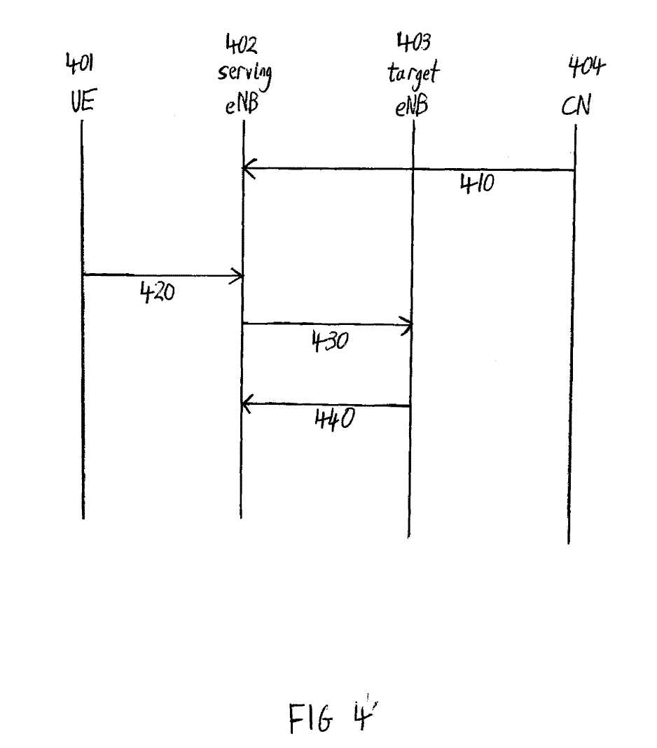

FIG. 4 shows a sequence diagram representing a process by which an active UE 401 may be allowed or prevented from handing over to a target cell.

During connection set up of the UE 401 on the serving cell (for example, during the set up of a voice call or data session) in step 410, the core network (CN) 404 may provide an eNB 402 controlling the serving cell with an indication as to whether or not the UE 401 is a special case UE (for example, an emergency services UE). In addition, or as an alternative, the CN 404 may provide the serving eNB 402 with an indication of which access class (AC) the UE 401 supports (for example, one of AC 0-9 or 11-15). The indication as to whether or not the UE 401 is a special case UE and/or the indication of which AC the UE 401 supports may be provided to the serving eNB 402 in a modification of the S1 signalling that takes place between the CN 404 and serving eNB 402 as part of the 3GPP standards during connection set up.

In step 420, the UE 401 subsequently reports to the serving eNB 402 a target (or candidate) cell for handover. A target eNB 403 serves the target cell.

Having received the report of the target cell, in step 430 the serving eNB 402 queries the target eNB 403 to enquire about the status of access class barring in the target cell—i.e. the access conditions of the target cell. The target eNB 403 will then respond in step 440 with information regarding access conditions of the target cell. The information regarding the current access condition may comprise, for example, an indication that only special case UEs (for example, emergency services UEs) are allowed to use the target cell and that all other types of UE are barred from using the target cell (i.e. it is a lot 4 cell), and/or an indication of the ACs (for example, ACs 0-9) that are barred from using the target cell (with the implication being that all other ACs are allowed to use the target cell), and/or an indication of the ACs (for example, AC 14) that are allowed to use the target cell (with the implication being that all other ACs are barred from using the target cell) and/or an indication of the ACs that are allowed to use the target cell and an indication of the ACs that are barred from using the target cell.

Communication between the serving eNB 402 and the target eNB 403 in steps 430 and 440 may be carried out using new X2 signalling between the serving eNB 402 and the target eNB 403, as a modification of 3GPP standards as defined in TS 36.300/Based on the response received from the target eNB 403 and the information that the serving eNB 402 has regarding the access permission of the UE 401 (for example, if it is a special case UE and/or the AC that the UE supports), the serving eNB can compare the access permission of the UE 401 to the access condition of the target cell either suppress handover of the UE 401 to the target cell if the access permission of the UE 401 does not comply with the access permission of the target cell, or it can allow the handover to take place in accordance with the standard handover process. For example, if the target eNB 403 has indicated that it has an access condition of allowing only special case UEs to use the target cell and the UE 401 is not a special case UE, the serving eNB 402 will prevent handover of the UE 401 to the target cell. In a further example, if the target eNB 402 has indicated that it has an access condition of barring ACs 0-9 (thus, allowing other ACs to use the target cell) and the UE's access permission supports an access class of 0-9, again the serving eNB 402 will prevent handover of the UE 401 to the target cell. In a further example, if the target eNB 403 has indicated that it has an access condition of allowing AC 14 to use the target cell and the UE's access permission supports an access class of 14, the serving eNB 402 will allow the standard handover process to take place such that the UE 401 is handed over to the target cell.

In an alternative, step 410 does not take place and the CN does not give the serving eNB 402 an indication of the access permission of the UE 401 at the time of connection set up. Instead, the serving eNB 402 may obtain the access permission of the UE 401 at any other time. For example, when the UE 401 requests a network service of handing over to the target cell, the serving eNB 402 may use the identifier of the UE 401 (for example, an IMPI or IMSI) to request from the CN an indication of the access permission of the UE 401, or the serving eNB 402 may use the identifier of the UE 401 to look up the access permission of the UE 401 that is stored on the serving eNB 402, or stored in a location, such as a database, that is accessible to the serving eNB 402. Alternatively, the UE 401 may indicate to the serving eNB 402 in step 420, or at any other time, what the access permission of the UE 401 is.

In a further alternative, which may or may not be implemented alongside the above described alternative, the serving eNB 402 may not determine the access condition of the target cell using steps 430 and 440 described above. Instead, it may request an indication of the access condition of the target cell from any other network entity, or it may look up the access condition of the target cell from a record that is stored on the serving eNB 402, or stored in a location, such as a database, that is accessible to the serving eNB 402.

In an alternative to the process described above and shown in respect in FIG. 4, a UE may be modified to make a handover decision for itself, which may be effective for both idle and active UEs. In particular, when a target cell has been identified, the UE may compare its own access permission against the access permission that is sent to it in the system information for the target cell. The UE can then decide whether or not to select the cell.

This, however, may be effective only for permanent access class barring cells. For example, Emergency Services cells (lot 4 cells) permanently have access class barring activated, which means only special services UEs can access. If we were to specify that UEs need to perform access class barring check before selecting/reselecting a cell, then all UEs will be doing this check. Even for cells where access class barring is turned on but there is not 100% barring, UE will perform barring check and decide not to camp on the cell. However, this action is useless as UE is not connecting immediately. It only makes sense to perform access check when UE needs to connect (would save the UE battery also).

Besides 100% access class barring, which allows UE to camp on the cell but block them at connection, there are two other means to block access to a cell:

1) cell reserved for operator use bit is system information.
2) cell barred bit in system information

If cell is barred, this means no UEs (emergency services UE or not) can access the cell and even emergency calls are not allowed on the cell, which may not be helpful for operating emergency services cells (lot 4 cells). If we set the ‘cell reserved for operator use’ bit in system information′, this will block access to class 0-9 and there is a specific behaviour for special access class UEs and emergency calls

When cell status is indicated as “not barred” and “reserved” for operator use for any PLMN,
UEs assigned to Access Class 11 or 15 operating in their HPLMN/EHPLMN shall treat this cell as candidate during the cell selection and reselection procedures if the field cellReservedForOperatorUse for that PLMN set to “reserved”.
UEs assigned to an Access Class in the range of 0 to 9, 12 to 14 shall behave as if the cell status is “barred” in case the cell is “reserved for operator use” for the registered PLMN or the selected PLMN.

This is defined in TS36.304

This means it is not possible to make emergency calls on cells ‘reserved’ for operator use as it is classed as ‘barred’. If there is not 100% access class barring on the cell, emergency calls are allowed unless system information indicate AC10 (for emergency calls) as not permitted

When cell status is indicated as “not barred” and “reserved” for operator use and:
If the UE is assigned an Access Class 11 or 15 (i.e. ES user) and if the cell belongs to the home PLMN or to any Equivalent Home PLMN (EHPLMN), then the UE shall treat this cell as candidate during the cell selection and cell re-selection procedures in Idle mode and in Connected mode.
else, UEs shall behave as if cell status “barred” is indicated using the value “not allowed” in the IE “Intra-frequency cell re-selection indicator” and the maximum value for T_{barred}.

Information on cell access restrictions for Access Classes is broadcast as system information. With respect to mobility from lot 3 to lot 4, according to 3GPP TS 36.304, the UE shall ignore Access Class related cell access restrictions when selecting a cell to camp on, i.e. it shall not reject a cell for camping on because access on that cell is not allowed for any of the Access Classes of the UE. A change of the indicated access restriction shall not trigger cell reselection by the UE.

Access Class related cell access restrictions shall be checked by the UE when starting RRC connection establishment procedure as specified in 3GPP TS 36.331.

Therefore, as specified in 3GPP TS36.304 specification for LTE, the access class barring restrictions from the network does not apply for idle mode mobility i.e. it only applies to Mobile Originated accesses (and also does not apply for Mobile Terminated Access). Moreover, access class barring restrictions do not apply for connected call mobility). This is because “if the MME [or eNB] is congested then the MME [respectively eNB] can avoid causing extra congestion by just not paging the mobile”. Hence, if the page arrives at the mobile, the mobile should answer it.

For the Circuit Switched Fall Back (CSFB), Access control for CSFB provides a mechanism to prohibit UEs to access E-UTRAN to perform CSFB. It minimises service availability degradation (i.e. radio resource shortage, congestion of fallback network) caused by mass simultaneous mobile originating requests for CSFB and increases the availability of the E-UTRAN resources for UEs accessing other services. When an operator determines that it is appropriate to apply access control for CSFB, the network may broadcast necessary information to provide access control for CSFB for each class to UEs in a specific area. The network shall be able to separately apply access control for CSFB, SSAC and enhanced Access control on E-UTRAN for Machines (delay tolerant devices).

Although specific embodiments have now been described, it will be recognised that a number of variations or modifications may be employed. For example, although the Emergency Service or Public Safety communication service has been considered herein, the techniques described may be applied to other types of system. Alternative network architectures may be employed, with the MME replaced by an alternative mobility management functionality, for instance. Similarly, the configuration of the core network may be changed.

In the above, each cell is generally described as being controlled by an eNB. It will be appreciated that an eNB can control one or many cells. It will also be appreciated that rather than using an eNB, any controller may be used to control the operation of a cell, for example a radio network controller (RNC) etc.

Furthermore, whilst the above described access barring techniques are described as being performed by an eNB, it will be appreciated that any suitably configured network controller may perform the techniques and exercise control over paging on a cell and/or control handover to a target cell in accordance with the present disclosure.

It will be understood that in the above, the term UE encompasses all network communications devices that can be used by an end user to communicate on a wireless network. For example, it may be a mobile electronics device, such as a mobile telephone, smartphone, tablet, laptop computer.

1. A wireless network controller for controlling the performance of a requested network service for a user equipment within a wireless network, the wireless network controller being configured to:
compare an access permission of the user equipment to an access condition of a wireless network cell associated with the requested network service; and
if the access permission of the user equipment does not comply with the access condition of the wireless network cell associated with the requested network service, suppress the requested network service such that the network service is not performed.

2. The wireless network controller of claim 1, wherein the requested network service is the broadcast of a paging message for the user equipment, and the wireless network cell associated with the requested network service is a wireless network cell on which the paging message is to be broadcast.

3. The controller of claim 2, wherein the paging message comprises an indication of the access permission of the user equipment.

4. The controller of either claim 2 or claim 3, wherein:
the access permission of the user equipment comprises an access class of the user equipment; and
the access condition of the wireless network cell on which the paging message is to be broadcast comprises an indication of the access classes that are allowed to use the wireless network cell on which the paging message is to be broadcast.

5. The controller of any of claims 2 to 4, wherein:
the access permission of the user equipment indicates whether or not the user equipment is a special case user equipment; and
the access condition of the wireless network cell on which the paging message is to be broadcast indicates if the wireless network cell on which the paging message is to be broadcast is reserved for special case user equipment or if other user equipment is allowed to use the wireless network cell on which the paging message is to be broadcast.

6. The controller of claim 5, wherein the special case user equipment is an emergency services user equipment.

7. The wireless network controller of claim 1 wherein the requested network service is the handover of the user equipment from a serving wireless network cell to a target wireless network cell, and the wireless network cell associated with the requested network service is the target wireless network cell.

8. The wireless network controller of claim 7, being further configured to:
query the access condition of the target wireless network cell; and
receive an indication of the access condition of the target wireless network cell.

9. The controller of either claim 7 or claim 8, bring further configured to:
receive the access permission of the user equipment from the core network during connection set up of the user equipment on the serving wireless network cell.

10. The controller of any of claims 7 to 9, wherein:
the access permission of the user equipment comprises an access class of the user equipment; and
the access condition of the target wireless network cell comprises an indication of the access classes that are allowed to use the target wireless network cell.

11. The controller of any of claims 7 to 10, wherein:
the access permission of the user equipment indicates whether or not the user equipment is a special case user equipment; and
the access condition of the target wireless network cell indicates if the target wireless network cell is reserved for special case user equipment, or if other user equipment is allowed to use the target wireless network cell.

12. The controller of claim 11, wherein the special case user equipment is an emergency services user equipment.

13. The controller of any preceding claim, wherein the controller is an Evolved Node B.

14. A method for controlling the performance of a requested network service for a user equipment within a wireless network, the method comprising:
comparing an access permission of the user equipment to an access condition of a wireless network cell associated with the requested network service; and
if the access permission of the user equipment does not comply with the access condition of the wireless network cell associated with the requested network service, suppressing the requested network service such that the network service is not performed.

15. The method of claim 14, wherein the requested network service is the broadcast of a paging message for the user equipment, and the wireless network cell associated with the requested network service is a wireless network cell on which the paging message is to be broadcast.

16. The method of claim 14, wherein the requested network service is the handover of the user equipment from a serving wireless network cell to a target wireless network cell, and the wireless network cell associated with the requested network service is the target wireless network cell.
